(19) United States
(12) Patent Application Publication
(10) Pub. No.: US 2024/0256247 A1
(43) Pub. Date: Aug. 1, 2024

(54) SYSTEMS AND METHODS FOR DECLARATIVE COMPOSITION OF INFRASTRUCTURE COMPONENTS OF A SOFTWARE PRODUCT DEFINITION FOR AUTOMATED END TO END DEPLOYMENT

(71) Applicant: JPMORGAN CHASE BANK, N.A., New York, NY (US)

(72) Inventors: Eyal LANTZMAN, Cambridge (GB); Suman Kumar ADDANKI, Chadds Ford, PA (US); Stephen LINDELL, Southampton (GB); Akhilesh GUPTA, West Chester, PA (US)

(21) Appl. No.: 18/160,627

(22) Filed: Jan. 27, 2023

(51) Int. Cl. G06F 8/61; G06F 8/71

(52) U.S. Cl. CPC G06F 8/61; G06F 8/71

(57) ABSTRACT

Systems and methods for automated end-to-end deployment of a software product are disclosed. A method may include: (1) receiving, by a software or software defined infrastructure product management computer program, a selection of a software product for installation to a platform; (2) retrieving, by the software or software defined infrastructure product management computer program, a software product abstraction for the software product; (3) executing, by the software or software defined infrastructure product management computer program, a provisioning workflow in the software product abstraction, wherein the provisioning workflow installs the software product on the platform; (4) configuring, by the software or software defined infrastructure product management computer program, inputs using a mapping of the inputs of the software product abstraction; and (5) configuring, by the software or software defined infrastructure product management computer program, outputs using a mapping of the outputs of the software product abstraction.

### BACKGROUND OF THE INVENTION

### 1. Field of the Invention

Embodiments relate generally to systems and methods for declarative composition of infrastructure components of a software product definition for automated end to end deployment.

### 2. Description of the Related Art

Platforms need to define, deploy and manage software product lifecycle, and get telemetry and usage metrics for those software products for effective management and evolution of the software product offering.

### SUMMARY OF THE INVENTION

Systems and methods for declarative composition of infrastructure components of a software product definition for automated end to end deployment are disclosed. In one embodiment, a method for automated end-to-end deployment of a software product may include: (1) receiving, by a software or software defined infrastructure product management computer program, a selection of a software product for installation to a platform; (2) retrieving, by the software or software defined infrastructure product management computer program, a software product abstraction for the software product; (3) executing, by the software or software defined infrastructure product management computer program, a provisioning workflow in the software product abstraction, wherein the provisioning workflow installs the software product on the platform; (4) configuring, by the software or software defined infrastructure product management computer program, inputs using a mapping of the inputs of the software product abstraction; and (5) configuring, by the software or software defined infrastructure product management computer program, outputs using a mapping of the outputs of the software product abstraction.

In one embodiment, the software product abstraction may include a list of modules in the software product, the provisioning workflow, and mappings of the inputs and outputs.

In one embodiment, the mappings of the inputs may be for the inputs to the software product and modules in the software product, and the mappings of the outputs may be for the outputs of the software product and modules in the software product.

In one embodiment, the software product abstraction may also include platform requirements for the software product.

In one embodiment, the selection of the software product may be received from a marketplace. A plurality of software products may be available in the marketplace.

In one embodiment, the selection of the software product may be received from a tenant of the platform.

According to another embodiment, a non-transitory computer readable storage medium, may include instructions stored thereon, which when read and executed by one or more computer processors, cause the one or more computer processors to perform steps comprising: receiving a selection of a software product for installation to a platform; retrieving a software product abstraction for the software product; executing a provisioning workflow in the software product abstraction, wherein the provisioning workflow installs the software product on the platform; configuring inputs using a mapping of the inputs of the software product abstraction; and configuring outputs using a mapping of the outputs of the software product abstraction.

In one embodiment, the software product abstraction may include a list of modules in the software product, the provisioning workflow, and mappings of the inputs and outputs.

In one embodiment, the mappings of the inputs may be for the inputs to the software product and modules in the software product, and the mappings of the outputs may be for the outputs of the software product and modules in the software product.

In one embodiment, the software product abstraction may also include platform requirements for the software product.

In one embodiment, the selection of the software product may be received from a marketplace. A plurality of software products may be available in the marketplace.

In one embodiment, the selection of the software product may be received from a tenant of the platform.

According to another embodiment, a system may include a software product abstraction database comprising a plurality of software product abstractions; a plurality of platforms; and an electronic device executing a software or software defined infrastructure product management computer program that receives a selection of a software product for installation to one of the plurality of platforms, retrieves one of the software product abstractions from the software product abstraction database for the software product, executes a provisioning workflow in the software product abstraction, wherein the provisioning workflow installs the software product on the platform, configures inputs using a mapping of the inputs of the software product abstraction, and configures outputs using a mapping of the outputs of the software product abstraction.

In one embodiment, the software product abstraction may include a list of modules in the software product, the provisioning workflow, and mappings of the inputs and outputs.

In one embodiment, the mappings of the inputs may be for the inputs to the software product and modules in the software product, and the mappings of the outputs may be for the outputs of the software product and modules in the software product.

In one embodiment, the software product abstraction may also include platform requirements for the software product.

In one embodiment, the selection of the software product may be received from a marketplace. A plurality of software products may be available in the marketplace.

In one embodiment, the selection of the software product may be received from a tenant of the platform.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for declarative composition of infrastructure components of a software product definition for automated end to end deployment according to an embodiment;

FIG. 2 depicts a method for declarative composition of infrastructure components of a software product definition for automated end to end deployment according to an embodiment;

FIG. 3 depicts an exemplary computing system for implementing aspects of the present disclosure.

### DETAILED DESCRIPTION OF PREFERRED EMBODIMENTS

Embodiments are generally directed to systems and methods for declarative composition of infrastructure components of a software product definition for automated end to end deployment.

Embodiments provide a platform that is domain-agnostic to platform domains and/or platform offerings. For example, if something can be installed, the platform can install it.

Embodiments may create a software product abstraction that represents a complete software product. The software product abstraction may include a list of modules, a provisioning workflow to install the modules, software product input (that maps to module inputs) and software product output (that maps to module outputs).

Embodiments may provide a platform that may install, uninstall, and/or upgrade a software product in a federated environment.

Embodiments may provide a metrics streaming from the federated environments into a central metrics and analytics store.

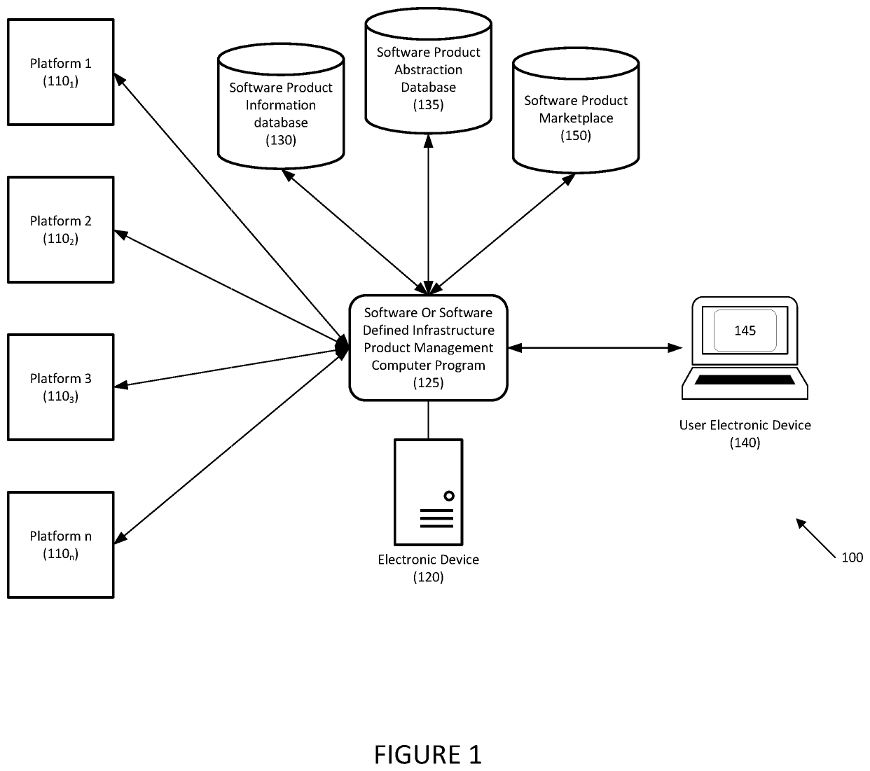

Referring to FIG. 1, a system for providing a managed infrastructure provisioning platform is disclosed according to an embodiment. System 100 may include a plurality of platforms (e.g., platform 110₁, platform 110₂, platform 110₃, . . . platform 110ₙ), such as cloud-based platforms. Platforms 110 may communicate with software or software defined infrastructure product management computer program 125, which may be executed by electronic device 120. Software or software defined infrastructure product management computer program 125 may manage the onboarding and deployment of software products, to platforms 110.

In addition, software or software defined infrastructure product management computer program 125 may also manage software product releases, software product migration, software product placements, quotas, etc. Additional databases (not shown) may be provided for each service as is necessary and/or desired.

Software or software defined infrastructure product management computer program 125 may interface with software product information database 130, which may maintain information on software products to be installed, such as modules, provisioning workflows, inputs, outputs, etc. In one embodiment, software product information database may be an external database.

In one embodiment, software product information database 130 may also maintain information on platforms 110, such as any specific installation requirements for each platform 110.

In another embodiment, each platform 110 may maintain information on itself and may provide it to software or software defined infrastructure product management computer program 125.

System 100 may further maintain software product abstraction database 135, which may maintain a software product abstraction for each onboarded software product. The software product abstraction may include, for example, a list of modules in the software product, a provisioning workflow to install the modules, software product inputs (e.g., that maps to module inputs), software product outputs (e.g., that maps to module outputs), etc.

The software product abstraction may be a schema or language for the standardized provisioning of different types of modules across different systems, in order to have a provisioned product.

Software product marketplace 150 may identify onboarded software products that are available to install on platforms 110. Software product marketplace 150 may provide a self-service interface via which platforms, users, etc. may select software products for installation.

System 100 may include user electronic device 140 that may be any suitable electronic device (e.g., workstations, computers, Internet of Things appliances, etc.). User electronic device 140 may execute user electronic device program 145 that may request installation of a software product on one of platforms 110. User electronic device 140 may also identify software products for onboarding and may configure software product abstractions as is necessary and/or desired.

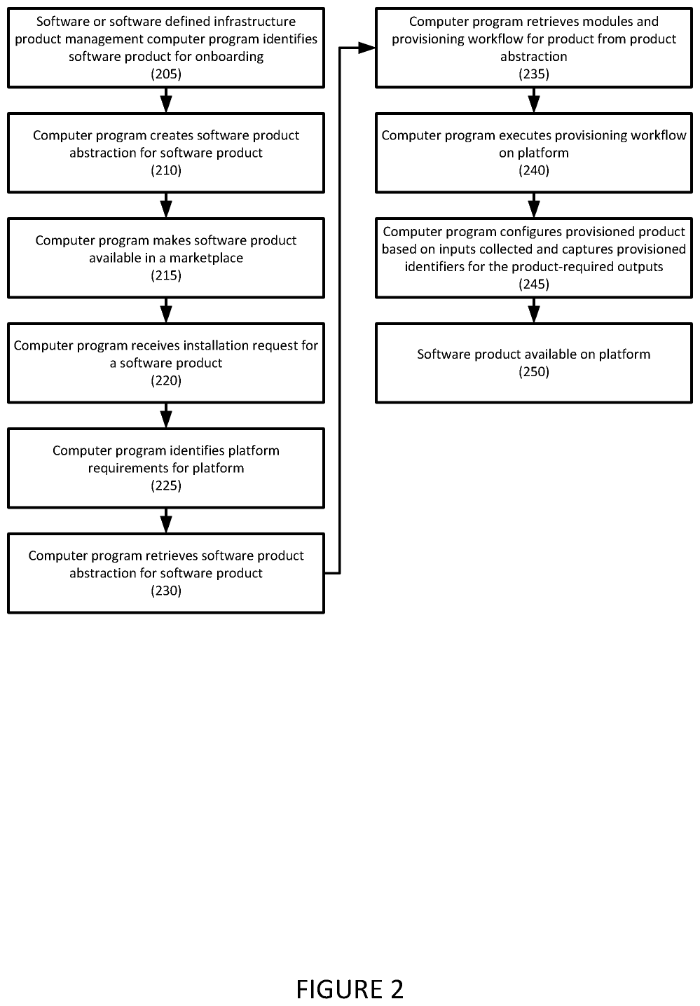

Referring to FIG. 2, a method for declarative composition of infrastructure components of a software product definition for automated end-to-end deployment is disclosed according to an embodiment.

In step 205, a software or software defined infrastructure product management computer program may identify a software product for onboarding for installation to a platform. In one embodiment, the software products may include computer programs, software applications, etc.

In one embodiment, if not registered already, the software product may be registered. The registration may identify the software product, the version of the software product, the inputs, the outputs, and the handler that will be able to interpret the inputs as the provisioning activity.

In one embodiment, the registration process may be a software development lifecycle process in which modules of the software process may be registered by pushing a payload, such as a JSON/YAML payload, into an API. Some modules may need a new handler to be deployed to support the interpretation of the module payload at runtime (e.g., for a module that creates an active directory group, the system would need to support such handler).

For example, during module registration, the module owner may provide a specification of the module interface (e.g., input, output) and the handler that will be interpreting the inputs, acting upon that input and returning the output. During product registration, the product owner may provide a specification of a module composition (e.g., input, output, provisioning flow etc.) of all the steps required to provision the product (across the different systems-cloud, identity, etc.).

In one embodiment, the module may reference a software and/or infrastructure versioned component that exists in a handle-specific authoritative source (e.g., a Java package in an artifact store that would be known by a Java handler that can dynamically pull that package and run it). A module may also include information in another system, such as which Java library name and version to call, what class in that library, etc.

A module may be handled by a handler that writes to the data bases, calls APIs, etc.

The registration may be considered to be a composition of referenced modules that were previously registered, and a stitching of inputs/outputs between the interface for the product and the interfaces for the module. For example, the product specification and inputs are generally sufficient to retrieve the modules, provisioning workflows, etc. and to provision the software product based on the input parameters.

In step 210, the software or software defined infrastructure product management computer program may create a software product abstraction for the software product and/or modules. In one embodiment, the software product abstraction may include, for example, a list of modules in the software product, a flow to install the modules, a mapping of inputs and outputs to the software product and/or modules, a provisioning workflow (e.g., sequential versus parallel), etc.

In step 215, the software or software defined infrastructure product management computer program may make the software product available for selection in a marketplace.

In step 220, a platform, tenant, etc. may identify a software product to install on a platform and may submit a request to the software or software defined infrastructure product management computer program for installation of the software product on a platform.

In step 225, the software or software defined infrastructure product management computer program may retrieve the software product abstraction for the requested software product.

In step 230, the software or software defined infrastructure product management computer program may identify any requirements to deploy the software product to the identified platform.

In step 235, the software or software defined infrastructure product management computer program may retrieve the modules and the provisioning workflow for the modules from the software product abstraction.

In step 240, the software or software defined infrastructure product management computer program may execute the provisioning workflow from the software product abstraction to install the modules on the platform.

For example, in one embodiment, a product specification for the software product may be loaded. The product specification may include standardized instructions to map inputs to the software product to the inputs to the modules as part of the module input mapping.

Next, the inputs for the software product and/or the modules that are identified in the product specification may be validated. In one embodiment, there may be required arguments and optional arguments. If the required augments were not provided, the provisioning will fail before the actual provisioning.

Next, a provisioning workload may be started with the input payload, such as the inputs to the software product. Some inputs may be defined at registration, and others may be defined at provisioning. The workflow may sequentially load the modules identified in the abstraction, and will resolve their inputs using the product specification.

The inputs may be resolved during product to module mapping and may be based on the registration logic. For example, product input Arg1 goes to module M1 Arg2. In one embodiment the product specification may identify the registration of the software product using in, for example, its module mappings.

Next, the provisioning workflow may delegate the work to specific handlers with the module payload. For example, the provisioning workflow may use specific handlers for the modules to install each of the modules. The provisioning workflow may then collect the output as a module output, such as the unique thing that they provisioned after the provisioning flow.

In one embodiment, the outputs of the software may be mapped to the outputs of the software modules. For example, the mapping may specify that output out1 of module X is used as software product output out1.

The provisioning workflow will repeat the process for all modules, and will make the outputs of the modules available as resolvable sources (e.g., to be inputs input other modules or as product outputs).

At the end of the process, which can succeed or fail, the product outputs from the product specification may be collected from the modules. For example, outputs may be collected for each module by its handler. The outputs may be used to connect one provisioned product to another. The inputs/outputs may be considered to be interfaces why which products may be connected.

The workflow may be pluggable, meaning that a different provisioning workflow may be specified as is necessary and/or desired. For example, the provisioning workflow may change based on priority, a dependency order instead of being sequential.

In one embodiment, metadata, such as priority and/or dependency, may be used to provide various provisioning flows.

In step 245, the software or software defined infrastructure product management computer program may configure the provisioned product based on the inputs collected, and may capture the provisioned identifiers for the product-required outputs.

In step 250, the software product may be made available on the platform.

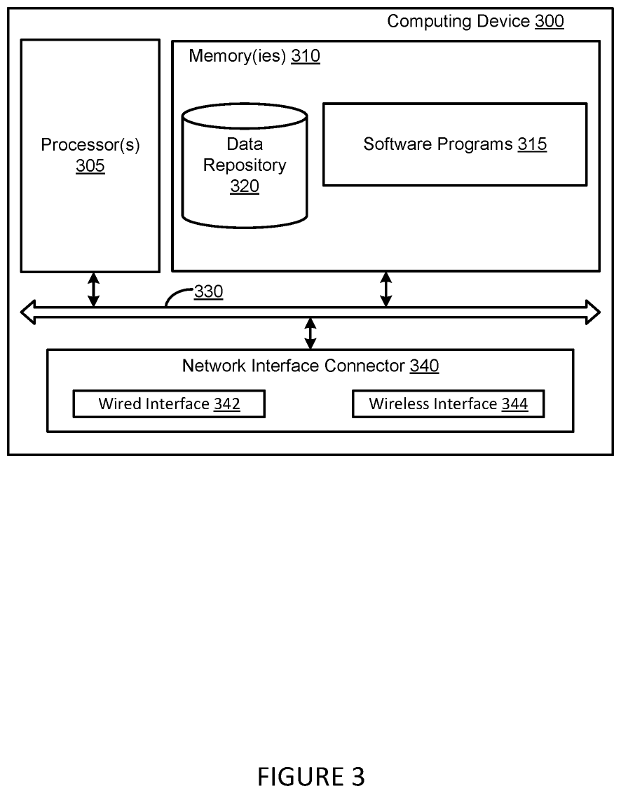

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for automated end-to-end deployment of a software product comprising:
receiving, by a software or software defined infrastructure product management computer program, a selection of a software product for installation to a platform;
retrieving, by the software or software defined infrastructure product management computer program, a software product abstraction for the software product;
executing, by the software or software defined infrastructure product management computer program, a provisioning workflow in the software product abstraction, wherein the provisioning workflow installs the software product on the platform;
configuring, by the software or software defined infrastructure product management computer program, inputs using a mapping of the inputs of the software product abstraction; and
configuring, by the software or software defined infrastructure product management computer program, outputs using a mapping of the outputs of the software product abstraction.

2. The method of claim 1, wherein the software product abstraction comprises a list of modules in the software product, the provisioning workflow, and mappings of the inputs and outputs.

3. The method of claim 2, wherein the mappings of the inputs are for the inputs to the software product and modules in the software product, and the mappings of the outputs are for the outputs of the software product and modules in the software product.

4. The method of claim 2, wherein the software product abstraction further comprises platform requirements for the software product.

5. The method of claim 1, wherein the selection of the software product is received from a marketplace.

6. The method of claim 5, wherein a plurality of software products are available in the marketplace.

7. The method of claim 1, wherein the selection of the software product is received from a tenant of the platform.

8. A non-transitory computer readable storage medium, including instructions stored thereon, which when read and executed by one or more computer processors, cause the one or more computer processors to perform steps comprising:
receiving a selection of a software product for installation to a platform;
retrieving a software product abstraction for the software product;
executing a provisioning workflow in the software product abstraction,
wherein the provisioning workflow installs the software product on the platform;
configuring inputs using a mapping of the inputs of the software product abstraction; and
configuring outputs using a mapping of the outputs of the software product abstraction.

9. The non-transitory computer readable storage medium of claim 8, wherein the software product abstraction comprises a list of modules in the software product, the provisioning workflow, and mappings of the inputs and outputs.

10. The non-transitory computer readable storage medium of claim 9, wherein the mappings of the inputs are for the inputs to the software product and modules in the software product, and the mappings of the outputs are for the outputs of the software product and modules in the software product.

11. The non-transitory computer readable storage medium of claim 9, wherein the software product abstraction further comprises platform requirements for the software product.

12. The non-transitory computer readable storage medium of claim 8, wherein the selection of the software product is received from a marketplace.

13. The non-transitory computer readable storage medium of claim 12, wherein a plurality of software products are available in the marketplace.

14. The non-transitory computer readable storage medium of claim 8, wherein the selection of the software product is received from a tenant of the platform.

15. A system, comprising:
a software product abstraction database comprising a plurality of software product abstractions;
a plurality of platforms; and
an electronic device executing a software or software defined infrastructure product management computer program that receives a selection of a software product for installation to one of the plurality of platforms, retrieves one of the software product abstractions from the software product abstraction database for the software product, executes a provisioning workflow in the software product abstraction, wherein the provisioning workflow installs the software product on the platform, configures inputs using a mapping of the inputs of the software product abstraction, and configures outputs using a mapping of the outputs of the software product abstraction.

16. The system of claim 15, wherein the software product abstraction comprises a list of modules in the software product, the provisioning workflow, and mappings of the inputs and outputs, the mappings of the inputs are for the inputs to the software product and modules in the software product, and the mappings of the outputs are for the outputs of the software product and modules in the software product.

17. The system of claim 15, wherein the software product abstraction further comprises platform requirements for the software product.

18. The system of claim 15, further comprising a marketplace comprising a plurality of software products available for installation, and wherein the selection of the software product is received from the marketplace.
